(19) United States
(12) Patent Application Publication
(10) Pub. No.: US 2002/0092987 A1
(43) Pub. Date: Jul. 18, 2002

(54) Photo detect device using quantum dots and materialization method thereof

(76) Inventors: Taehee Cho, Suwon-si (KR); Songcheol Hong, Taejon-si (KR)

Correspondence Address: Gregory P. LaPointe, BACHMAN & LaPOINTE, P.C., Suite 1201, 900 Chapel Street, New Haven, CT, 06510-2802, US

(21) Appl. No.: 10/056,437

(22) Filed: Jan. 23, 2002

Related U.S. Application Data
(63) Continuation-in-part of application No. 09/337,452, filed on Jun. 21, 1999.

(30) Foreign Application Priority Data
Sep. 5, 1998 (KR) 98-36658

(51) Int. Cl. G01J 5/20

(52) U.S. Cl. 250/338.4; 438/57

(57) ABSTRACT

There is disclosed a photo detect device using quantum dots, which can detect incident light effectively and be operated at room temperature without additional equipment or treatments. The photo detect device, in which the transfer and channels of carriers are set in the horizontal direction by heterointerfaces insulator/semiconductor interface and/or impurity doping and the magnitude of the currents which flow through the channels is determined by the control of Fermi level, can be materialized by a method comprising the steps of: forming quantum dot layers at predetermined positions near the channels in such a manner that the carriers should be released from the quantum dot layers in response to the detection of light and accumulated in the channels; and providing the Fermi level at an activation position by confining the carriers within the quantum dot layers while limiting the number of the carriers in the channels for the purpose of minimizing a current flow in the absence of incident light.

### BACKGROUND OF THE INVENTION

1. Field of the Invention

The present invention relates, in general, to a photo detect device and, more particularly, to a photo detect device using quantum dots, which can detect incident light effectively. Also, the present invention is concerned with a method for materializing such a photo detect device.

2. Description of the Prior Art

Generally, light can be divided by wavelength bands in which a considerable quantity of rays with various frequencies coexist, as shown in FIG. 1. The wavelength band of the visible light ranges from about 0.4 to 0.7 μm while the ultraviolet light and the infrared light have a wavelength band ranging from 0.01 to 0.4 μm and 0.7 to 1,000 μm, respectively.

In FIG. 1, photon energies are given along a separated horizontal axis, and the energy conversion by light wavelengths follows the Equation 1:

$$λ ( µ m ) = \frac{c}{v} = \frac{hc}{hv} = \frac{1.24}{hv ( e V )} 25 \qquad [ 1 ]$$

wherein c is the velocity of light in vacuum, v represents a frequency of light, h is the Plank's constant, and hv is a photon energy represented in eV units. According to this equation, the photon energy of the green light, which is 0.5 μm in wavelength, is calculated to 2.48 eV.

Photodevices for detecting or generating particular light are typically based on the interactions between photons and electrons. The interactions between photons and electrons in a solid include three fundamental procedures, such as absorption, natural release and inductive release.

The devices using the interactions between photons and electrons in solids, that is, photodevices, are operated by quantums, the particle-like behavior light components. Representative examples of the photodevice include light-emitting diodes which convert electric energies into light energies, diode laser devices, photo detect devices which detect electrically optical signals, and solar cell devices which convert light energies to electric energies.

The optical signals described hereinafter mean the signals pertaining not to visible light, but to infrared light (conventional photodetectors and methods are sufficient to detect visible light).

The photo detect devices of such various photodevices are largely subject to pyroelectric devices which convert into electric signals the differences of temperatures which vary within the devices, depending on the presence or absence of light and photon type detect devices which are responsive to the photons of incident light. Now prevailing are the photon type detect devices by virtue of their high quantum efficiency and fast response speed.

To materialize such photon-type detect devices, there is used either the transition between the valence band and conduction band in a semiconductor having a small band gap, as shown in FIG. 2a, or the transition between the sub-bands within the conduction bands or valence bands of the multiple quantum wells which are created by fabricating semiconductors having a relatively large band gap and semiconductors having a larger band gap, alternatively, as shown in FIG. 2b. For each type, there are exemplified a detect device using MCT, a compound of Group II-VI and a detect device with multiple quantum wells using GaAs/AlGaAs, a compound of Group III-V.

In the case of using a semiconductor having a small band gap, like the MCT detect device, it is difficult to handle matter having such a small band gap. Further, fabrication processes therefor are not uniformly applied to a large area of such matter, so that it is not suitable for a detect device array with a large area. In addition, the matter small in band gap has a bad influence on the production yield of the device.

For the multiple quantum well-type detect devices, conventional Si or GaAs substrates can be utilized, so that familiar processes, as they are, are applicable. Thus, process uniformity can be achieved even on the substrates of large areas. In addition, their excellent thermal uniformity allows the substrates to be suitably used for photo detect device arrays of large areas (see, R. Peopol et al., Appl. Phys. Lett. 61(9):1122 (1992)).

Because the multiple quantum well-type photo detect devices are susceptible only to the polarized light component coincident with the growth direction of the multiple quantum wells, (e.g. the polarized light component perpendicular to the surface of the multiple quantum wells) (see, C. L. Yang et al., J. Appl. Phys. 65:3253 (1989)), the photo detect devices suffer a disadvantage in that they are unable to effectively sense the incident light perpendicular to the surface of the multiple quantum wells in which there exist only the polarized light components horizontal to the surface.

The problems which conventional multiple quantum well-type photo detect devices possess will now be described in more detail with reference to the accompanying drawings.

FIG. 3 shows a conventional multiple quantum well-type photo detect device, which comprises a substrate with multiple quantum wells arranged between an overlying detect layer and an underlying earth layer. This conventional device is susceptible particularly to the polarized light coincident with the growth direction of the multiple quantum wells. Because the perpendicularly incident light in FIG. 3, (e.g., the incident light perpendicular to the side surface of the multiple quantum wells) has a polarized light component (Z) which is coincident with the growth direction of the multiple quantum wells, the polarized light component is detected effectively. On the other hand, in the case of the horizontally incident light in FIG. 3, (e.g., the incident light perpendicular to the upper or lower surface of the multiple quantum wells), its polarized light components (X, Y), which are perpendicular to the growth direction of the multiple quantum wells, are detected by the conventional device, but at a very low efficiency.

Various efforts have been made to effectively detect the incident light perpendicular to the upper or lower surface of multiple quantum wells, and, as a result, there were suggested three representative prior arts which will be described, below.

First, there is disclosed a photo detect device which has a biased side surface of multiple quantum wells (J. S. Park et al., Appl. Phys. Lett. 61(6):681(1992)), in which, when light is incident on the biased side surface, a perpendicular polarized light component, coincident with the growth direction of the multiple quantum wells, is generated and used to detect the light.

Because the biased side surface of the multiple quantum wells is made by mechanically grinding, chemically etching or the combination thereof, the process is very instable. Neither 2- or higher dimensional array structures nor mass production is possible in this manner.

As a solution to solve these problems, there was proposed a photo detect device which has a diffusely reflecting means on its upper surface (G. Sausi et al., Appl. Phys. Lett. 64(8):960(1993)). When light is perpendicularly incident from the rear of a multiple quantum well structure, the light is diffusely reflected by the reflector, and the perpendicular, polarized light component of the reflected light, coincident with the growth direction of the multiple quantum wells, is used to detect the incident light.

This photo detect device, however, has a significant problem in that the additional equipment of such a diffusely reflecting means increases the production cost and the light diffusely reflected may affect neighboring devices.

The final representative conventional photo detect device is exemplified by one in which the upper surface of a multiple quantum well structure is etched in a V-shaped pattern (C. J. Chen et al., Appl. Phys. Lett. 68(11):1446(1996)). When light is incident from the rear of the multiple quantum well structure, it is reflected from the slant of the V pattern and the perpendicular polarized light component of the reflected light, coincident with the growth direction of the multiple quantum wells, is used to detect the incident light.

The etching in a V pattern is somewhat cumbersome. In addition, the fact that must be done directional etching after multiple quantum well formed, the number of the wires formed in a V shape per area must be increased to enhance the detect efficiency and that a resistant contact must be made at the pointed part of the V pattern, acts as a significant barrier in utilizing the conventional photo detect device.

Conventional photo detect devices developed thus far, are large in dark current, so they should be maintained at very low temperatures, for example, a liquid nitrogen temperature, for the purpose of efficient photo detection. At room temperature, their operation is impossible. In fact, conventional multiple quantum well-type photo detect devices are mounted in vacuum containers and cooled with the aid of a freezer for the purpose of their operation.

### SUMMARY OF THE INVENTION

It is an object of the present invention to overcome the above problems encountered in prior arts and to provide a photo detect device which effectively detects the light incident normally on its surface and is operable at room temperature without additional equipment or treatments.

It is another object of the present invention to provide a method for materializing such a photo detect device.

In accordance with an aspect of the present invention, there is provided a materialization method of a photo detect device using quantum dots, in which the transfer and channels of carriers are set in the horizontal direction by heterojunction or impurity doping and the magnitude of the currents which flow through the channels is determined by the control of Fermi level, comprising the steps of: forming quantum dot layers at predetermined positions near the channels in such a manner that the carriers should be released from the quantum dot layers in response to light detection and accumulated in the channels; and providing the Fermi level at an activation position by confining the carriers within the quantum dot layers while limiting the number of the carriers in the channels for the purpose of minimizing a current flow in the absence of incident light.

The materialization method is characterized in that light is infrared light ranging, in wavelength, from 0.77 μm to 100 μm.

In accordance with another aspect of the present invention, there is provided a photo detect device using quantum dots, comprising: at least one quantum dot layer containing the quantum dots which are not doped with impurities under a control; at least one light absorption layer containing at least one quantum dot layer, which is formed by alternating the quantum dot layer and a material different in band gap from the quantum dot layer; a conduction path layer, in contact with the light absorption layer, in which carriers excited in the light absorption layer are collected and conducted in a horizontal direction; an impurity-containing layer in which impurities are so controlled in amount and distribution as to provide the carriers to the light absorption layer, but not to the conduction path layer; at least two detect electrodes for conducting in the horizontal direction the carriers which are accumulated in the channels in response to the light incident on the light absorption layer; and one contact layer on the top of the device on which the detect electrodes are formed to collect and to provide carriers.

The photo detect device is characterized in that the detect electrodes have a distance therebetween which is longer than the wavelength of the incident light.

The photo detect device is additionally characterized in that the distribution of the impurities in the impurity-containing layer takes a shape of a delta function.

The photo detect device is additionally characterized in that impurity-containing layer has a uniform distribution of the impurities therethrough and is etched to control the carriers provided to the quantum dots.

An additional characteristic of the photo detect device is that the impurity-containing layer and the light absorption layer are formed adjacent to the conduction path layer, respectively.

Another characteristic of the photo detect device is that the impurity-containing layer and the light absorption layer are formed beneath and on the conduction path layer, respectively.

Another characteristic of the photo detect device is that the impurity-containing layer and the light absorption layer are made to have different band gaps so as to be subjected to heterojunction.

The photo detect device may further comprise at least one control electrode for controlling the amount of the carriers provided to the light absorption layer.

The photo detect device is characterized in that two or more control electrodes are used and provided sequentially with electric fields different in magnitude, so as to detect the carriers accumulated in the channels beneath the control electrodes, in sequence.

Another characteristic of the photo detect device resides in that the control electrodes are formed into at least two layers lest the electrodes in one layer overlap completely with those in another layer, a matter with a large resistance is interposed between the control electrode layers, and electric fields different in magnitude are subsequently applied to the control electrodes, whereby the charges accumulated in the channels beneath the control electrodes can be, in sequence, detected.

Another characteristic of the photo detect device resides in that impurities which are opposite, in type, to those in the impurity-containing layer are doped below the bottom layer of the control electrode, to reduce leak currents of the control electrodes.

Another characteristic of the photo detect device resides in that a highly resistant layer is provided below the bottom layer of the control electrodes to reduce leak currents of the control electrodes.

In accordance with a further aspect of the present invention, there is provided a method for fabricating a quantum dot-employing photo detect device, comprising the steps of: growing a light absorption layer in such a way that quantum dots are naturally formed in the course; depositing at least one electrode on a contact layer to show horizontal conduction; reducing the resistance between the electrode and the contact layer; etching the edge of the device to an extent necessary to reduce an electrical connection to other neighboring devices; etching the contact layer to a depth necessary to control the amount of carriers provided to the quantum dots; depositing at least one control electrode for controlling the carriers provided to the quantum dots; depositing an insulating film to prevent a short circuit from being formed between the electrodes; and etching a predetermined portion of the insulating film to transfer desired electrical signals to the outside of the insulating film.

### BRIEF DESCRIPTION OF THE DRAWINGS

The above and other objects and aspects of the invention will become apparent from the following description of embodiments with reference to the accompanying drawings in which:

FIG. 1 is an electromagnetic spectrum ranging from an ultraviolet region to an infrared region;

FIGS. 2a and 2b are schematic views respectively showing the transition from a valence band to a conduction band and the transition from a sub-band of a high energy to a sub-band of a lower energy within a conduction band or valence band, in response to incident light;

FIG. 3 is a schematic perspective view showing a face on which light is incident and the polarized components of the incident light in a photo detect device having a multiple quantum well structure;

FIG. 4 is a schematic perspective view showing a face on which light is incident and the polarized components of the incident light in a photo detect device having a quantum dot structure;

FIGS. 5a to 5d show energy density functions for a bulk, a proton beam and a quantum well, Fermi-Dirac energy distribution functions, and carrier distribution functions against energy, obtained from the relation between the previous functions;

FIGS. 6a and 6b are diagrams illustrating the formation of channels of a general semiconductor device;

FIGS. 7a and 7b are diagrams illustrating the formation of channels in a photo detect device using quantum dots in accordance with the present invention;

FIG. 8 is a schematic cross section showing a photo detect device using quantum dots in accordance with an embodiment of the present invention;

FIG. 9 is a schematic cross section showing a photo detect device using quantum dots in accordance with another embodiment of the present invention;

FIGS. 10a and 10b are graphs for measuring the detectivity of the photo detect device using quantum dots in accordance with an embodiment of the present invention;

FIGS. 11a and 11b are energy band diagrams of the photo detect device in accordance with an embodiment of the present invention;

FIGS. 12a and 12b illustrate the confinement state of electrons within the quantum dots;

FIG. 13 is a plan view showing a photo detect device in accordance with a further embodiment of the present invention;

FIGS. 14a and 14b are a schematic cross section showing a photo detect device using quantum dots and double heterostructure conducting path in accordance with another embodiment of present invention; and

FIG. 15 is a schematic cross section showing a photo detect device using quantum dots and Si/SiO₂ conducting path in accordance with another embodiment of present invention.

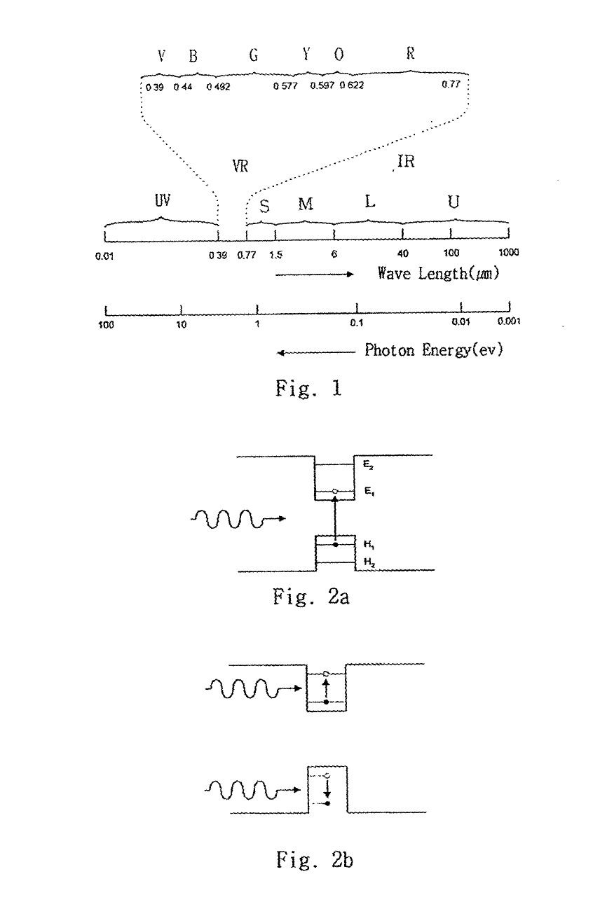

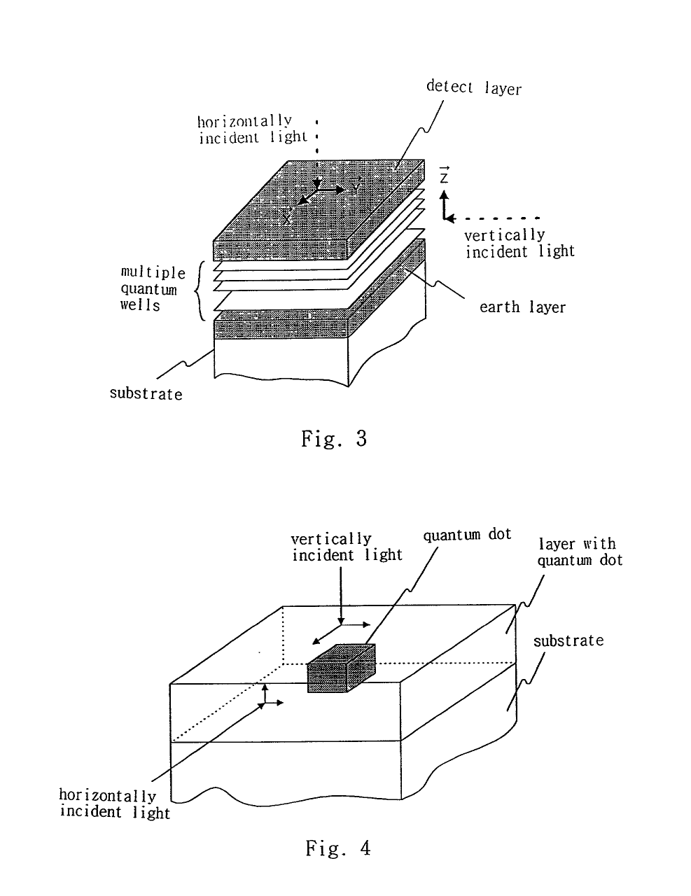

### DETAILED DESCRIPTION OF THE INVENTION

The present invention uses an array of quantum dot structures to avoid the features and technical limits which quantum wells possess. Like an island, a quantum mass which is present in a particular physical layer is called a quantum dot, as shown in FIG. 4.

According to the operation principle of a photo detect device using an array of quantum dot structures, the quantum dot can quantize the horizontally polarized component of the incident light perpendicular to the surface of the photo detect device (e.g., the polarized component horizontal to the surface of the detect device), by virtue of the feature of the fabricating processes (e.g., the feature that the material for quantum dots) is grown, not in a mono-direction, but in a radial direction, due to the cohesion of the material itself. Thus, the photo detect devices using quantum dot structures do not require the above-described additional equipment or processes, such as a diffusely reflecting means or an etching process for the V pattern, which are needed for solving the problem in that a photo detect device using multiple quantum wells cannot detect the polarized component horizontal to the surface of the quantum wells.

Further, quantum dots allow the fabrication of a photo detect device susceptible to the incident light perpendicular to its surface as well as operable at room temperature without the aid of an additional freezer.

The ability of the photo detect device using quantum dots to susceptibly respond to the incident light perpendicular to its surface, is attributed to the fact that, as shown in FIG. 4, the photo detect device using the transition between the sub-bands within conduction bands, can absorb only the polarized components which are in the quantized directions according to the selection rule of the transition.

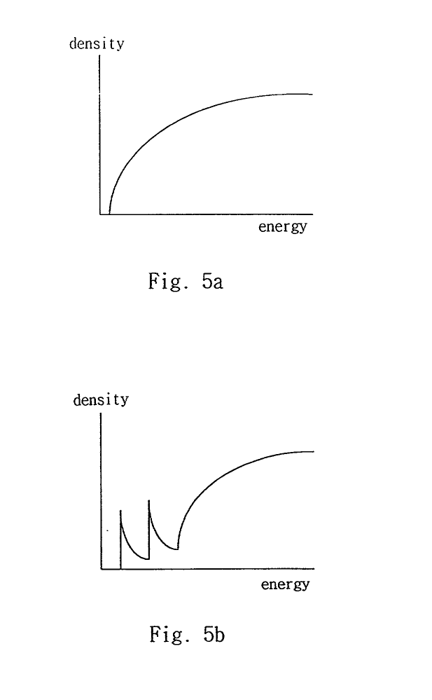

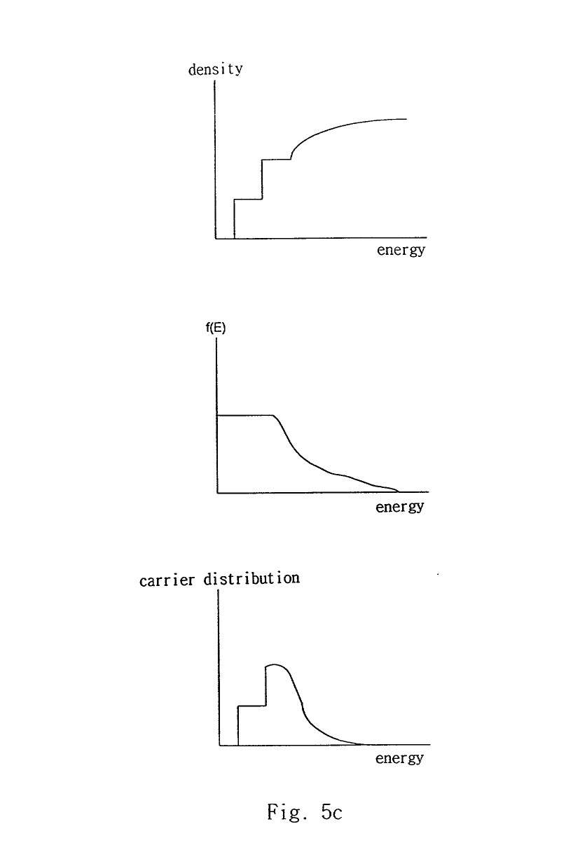

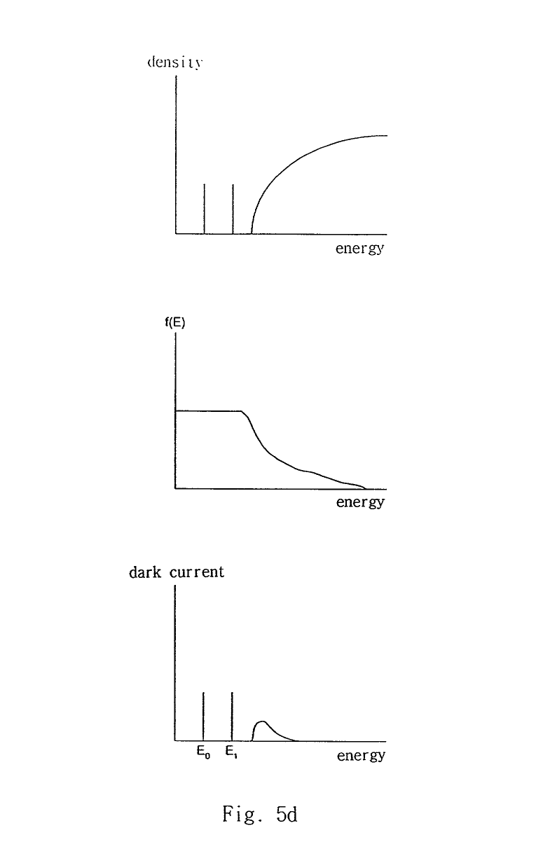

Particularly, the reason why the operation of the photo detect device using quantum dot structures is possible at room temperature without the aid of a freezer is as follows. For the energy-density function of the quantum dot, the density takes a form of a delta function, with regard to the energy, as shown in FIG. 5d. At this time, since the energy distance (E1−E0) can be made larger than the energy of optical phonons (ca. 36 meV), the energy transfer by the optical phonons is prevented. This gives rise to a remarkable decrease in the dark current, enabling the device to be operated at room temperature.

An energy density function for a bulk is shown in FIG. 5a, an energy density function for a proton beam in FIG. 5b, and an energy density function for a quantum well, a Fermi-Dirac energy distribution function and a carrier distribution function against energy, obtained from the relation between the previous two functions, in FIG. 5c. FIG. 5d gives the reason why the above-explained photo detect device using quantum dots is operable at room temperature, and shows an energy density function for a quantum dot, a Fermi-Dirac energy distribution function and a carrier distribution function against energy, obtained from the relation between the previous two functions.

As described above, the quantum dot is quite attractive in fabricating photo detect devices. So, there have been made attempts to fabricate the photo detect devices with quantum dot structures. However, these attempts tried still remain in the level of confirming the optical Features of quantum dots. The development of a photo detect device using quantum dots has been not achieved yet. Particularly, there are no success reports regarding the detect devices operable at room temperature.

Now, several representative examples of the development techniques for the photo detect devices using the quantum dots, which are being carried out, will be explained along with their advantages and disadvantages.

N-type delta doped space layers and quantum dot layers are alternatively grown 30 times. The side of a device is made slant by applying a form of a multipath optical waveguide, that is, the first manner described above for the multiple quantum well-type photo detect device (J. S. Park et al., supra). The structure thus obtained is used to ascertain the light absorption of the polarized component which is perpendicular to the polarized component horizontal to the surface of the device (S. Sauvage et al., Appl. Phys. Lett. 71(19):2785 (1997)).

This technique is inapplicable to mass production because the mechanically grinding, chemically etching or the combination thereof taken to make the side of the device slant is so instable. Further, this technique has another disadvantage of not accomplishing two- or higher dimensional matrix structures.

Another technique is to alternatively grow directly doped quantum dot layers and space layers ten times and to apply the upper and lower parts of the resulting light absorption structure with an electric field in the perpendicular direction to the structure. A metal layer on the upper surface of the device is formed empty at its central site and light is incident through the empty space of the metal layer to excite electrons. At this time, the light can be detected by taking advantage of perpendicularly directed electric field's conduction of the electrons (J. Phillips et al., Appl. Phys. Lett. 72(16):2020(1998)).

The technique suggested by J. Phillips et al., however, has a disadvantage in that the conduction in the normal direction to the upper surface of the device brings about a large noise owing to the great influence of the quantum layers and the impurity layers on the electric conduction, increasing the possibility in which a leak current might be generated by the crystal defectives of the perpendicularly directed diode structures. In result, no responses to light at room temperature have been reported yet.

Finally, a quantum dot is formed by making a depleted area and a non-depleted area locally over multiple quantum wells by use of electrodes (J. Allam and M. Wagner, UK Pat. No. 9125727:1991, U.S. Pat. No. 5291034:1994). The quantization in the horizontal direction requires a narrow gap between the electrodes. However, it is difficult to produce the electrodes with a sufficiently narrow gap. Further, the boundary of the depleted area is not accurately defined.

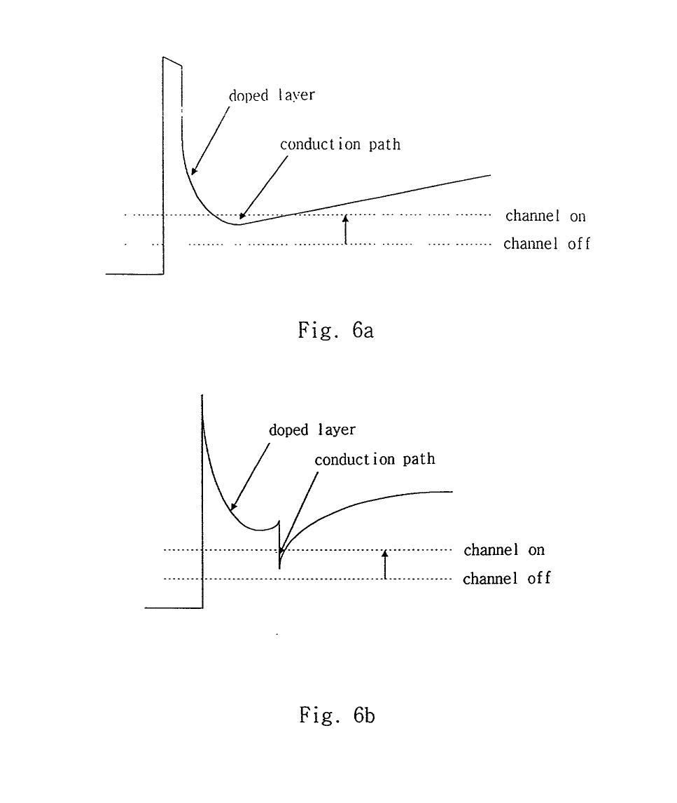

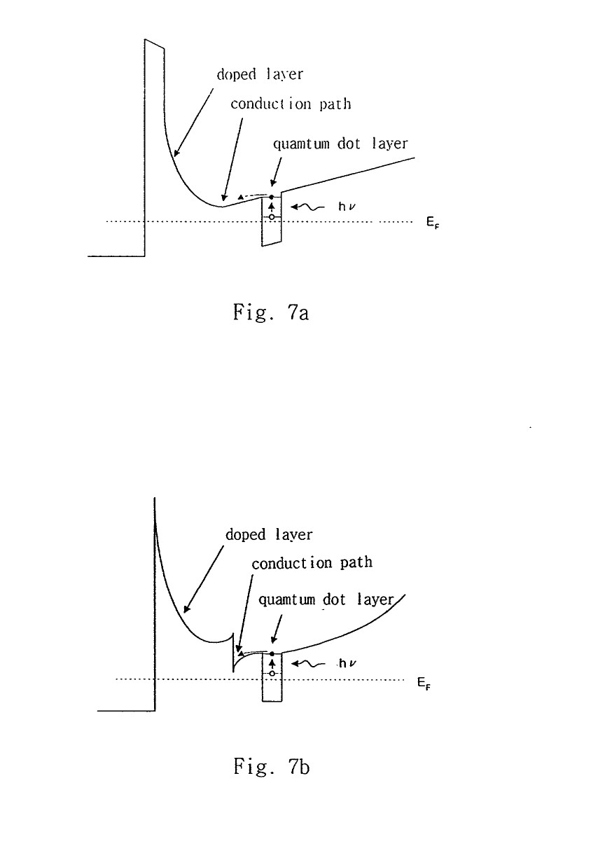

The photo detect device using quantum dots described hereinafter, characteristic of horizontal conduction, can detect the incident light perpendicular to its surface and be operated at room temperature, efficiently and susceptibly without an additional treatment or equipment as well as be fabricated into a mono or multi-dimensional matrix structure, economically, and a concept introduced for this purpose will now be described with reference to FIGS. 6a to 7b.

FIGS. 6a and 6b illustrate the channel formation of a typical semiconductor device. When the Fermi level represented by a dot line is moved toward a conduction path, the corresponding device is in a channel ON state, so that an electrical connection occurs, providing information regarding to what extent the corresponding device is operated under a particular condition.

Thus, in accordance with the present invention, a quantum dot layer is formed in such a conventional semiconductor of FIG. 6 and few carriers are present in a channel region under the condition of no incident light with a large quantity of carriers in the quantum dot layer, as shown in FIG. 7. When the quantum dot layer recognizes, in other words, when the quantum dot layer absorbs a photon, the carriers inside the quantum dot layer are released therefrom and accumulated in a conduction path, enabling the device to be in a turn-ON state.

Depending on the light recognized by the quantum dot layer, the amount of the carriers accumulated in the conduction path is changed. By electrically recognizing this change from the outside, the change of the light can be detected.

Though the photoconductive gain mechanism is explained by using the Fermi level positions as above according to the FIG. 7(a) and (b), further explanations will be given as follows.

Once carriers are released from the quantum dot layer by absorbing photons, the carriers with electric charges (i.e., negative for electron) move spatially to the channel layer (conduction path layer) and the resulting vacancy in the quantum dot causes electric potential changes around the quantum dot region including the channel region.

This is also the very reason why the quantum dots are placed near the channel in the present invention. The term “near the channel” means a distance wherein the quantum dots influence the potential of the channel by accumulating carriers in the channel layer. Therefore, the channel draws many carriers from source Ohmic contact. This could be described as the channel potential may be placed under the Fermi level and the device is turn-on state. This situation is continued until the vacancy originated by the absorption is refilled by other carriers. When the probability of refilling the quantum dot layer is not so high, one photon absorption makes many electron flows in the channel. The detecting current from the electrodes of the device is consisted of the photocarrier current and electrically induced-carrier current. This gain mechanism is so called photoconductive gain in the present structure.

The application of the preferred embodiments materialized according to the present invention is best understood with reference to the accompanying drawings, wherein like reference numerals are used for like and corresponding parts, respectively.

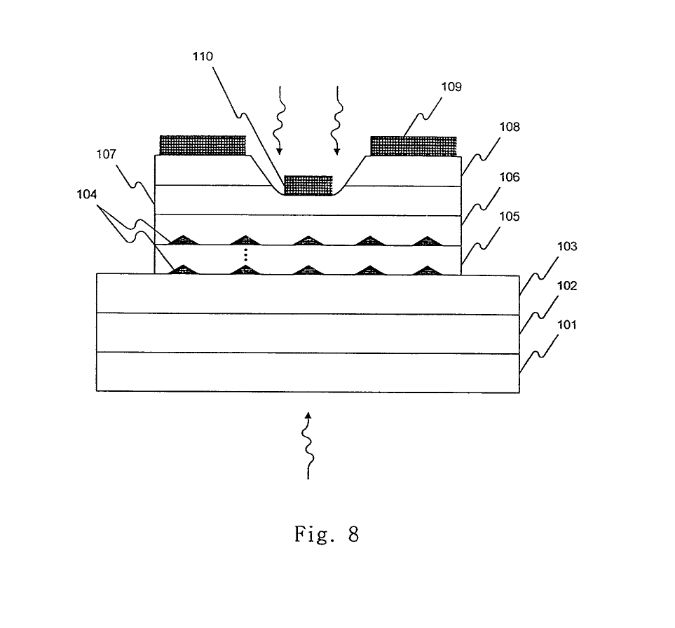

FIG. 8 is a section through a photo detect device using quantum dots according to a first embodiment of the present invention. As shown in this figure, the photo detect device materialized according to the first embodiment comprises a GaAs semiconductor substrate 101 grown accurately in the growth direction 001, on which a GaAs buffer layer 102 and a GaAs/AlGaAs super lattice buffer layer 103, both acting to prevent a leak current from flowing to the substrate 101, are subsequently fabricated.

Over the GaAs/AlGaAs super lattice buffer layer 103, arrays of InAs quantum dots 104 growing by “Stranski-Krastanow” growth mode and GaAs space layers 105 are alternatively stacked. If the arrays of the InAs quantum dots 104 compose five stories, the GaAs space layers 105 have four stories. Each of the GaAs space layers 105 serves as a potential barrier between the arrays of the InAs quantum dots 104.

Further, a GaAs conduction path layer 106, an AlGaAs layer 107 doped nonuniformly with n⁺ impurities, and an n⁺ GaAs ohmic contact layer 108 for a resistant contact over the top array of InAs quantum dots 104 are formed in sequence.

In addition, there are provided at least two detect electrodes 109, serving as drain or source terminals, with a control electrode 110 for controlling a Fermi level, therebetween. In consequence, the photo detect device using quantum dots according to the first embodiment of the present invention is structured to have at least two electrodes 109 for detecting the signals transferred in the horizontal direction with an electrode for controlling the carriers provided to an infrared absorption layer, therebetween, so that the dark current can be decreased and the infrared light incident normally on the top or bottom surface of the device can be detected.

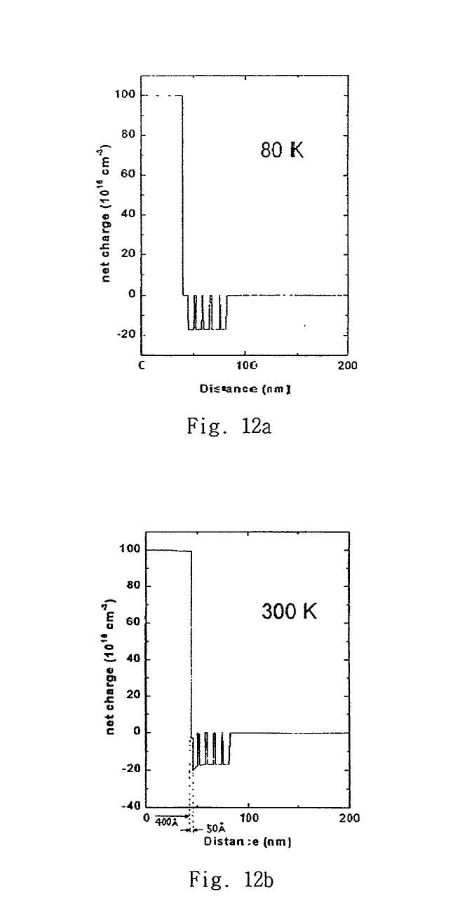

In the absence of incident infrared light, the carriers which are provided from the n⁺-doped AlGaAs layer 107 are almost absent in the conduction path layer 106, but confined within the quantum dots 104, which will be, in detail, explained later with reference to FIGS. 12a and 12b.

When infrared light is incident on the device, the photon energy of the light excites into the potential barrier edge side of the quantum dots the carriers confined within the quantum dots. The carriers are accumulated in the channels by the electric field which is internally formed by the bent potential owing to the nonuniformly doped n⁺ impurities in the AlGaAs layer 107, as explained in FIGS. 7a and 7b.

If an electric field is applied to the electrodes 109 under the confinement of the carriers within the channels, the carriers are detected at the source or drain terminal, depending on the direction of the electric field.

At this time, the channel can be formed in the space layers 105 while the majority of two-dimensional (2-D) electron gas is collected in the conduction path layer 106.

In this embodiment, the electrodes described above are formed as follows: First, after the layers 102 to 108 are formed over the GaAs substrate 101, the electrodes 109 are deposited at a regular distance on the n⁺ GaAs ohmic contact layer to detect the signals which are generated when the carriers excited by infrared light are subjected to the conduction in the horizontal direction. Then, the layer 108 is etched at the region between the electrodes 109 until a layer large in electrical resistance is exposed so as to reduce an electrical connection to other devices. Again, the region between the electrodes 109 is etched to a predetermined depth in order to primarily control the carriers provided to the infrared absorption layer. On the etched layer is deposited the control electrode 110 through which external electrical signals are used to control the amount of the carriers provided to the infrared absorption layer. In result, the infrared light incident on the top or bottom surface of the device can be detected.

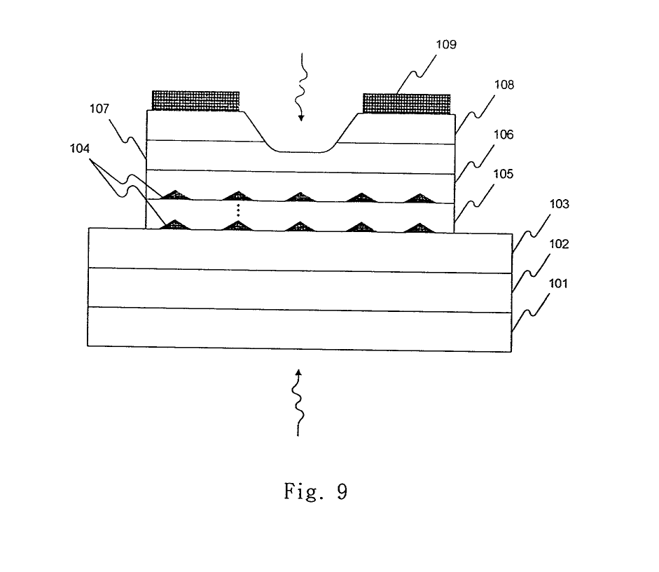

With reference to FIG. 9, there is shown a photo detect device, omissive of the control electrode 110 of FIG. 8, according to a second embodiment of the present invention. This photo detect device has such an optimal structure that the impurity concentration in the impurity layer for providing carriers to the quantum dots and the depth of the concaved layer are tuned to maximize the response region of incident infrared light on the top surface.

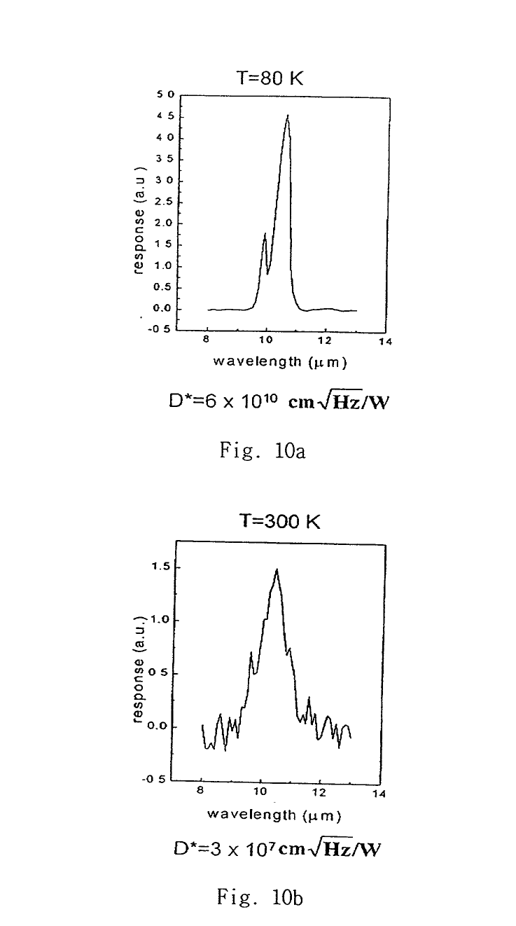

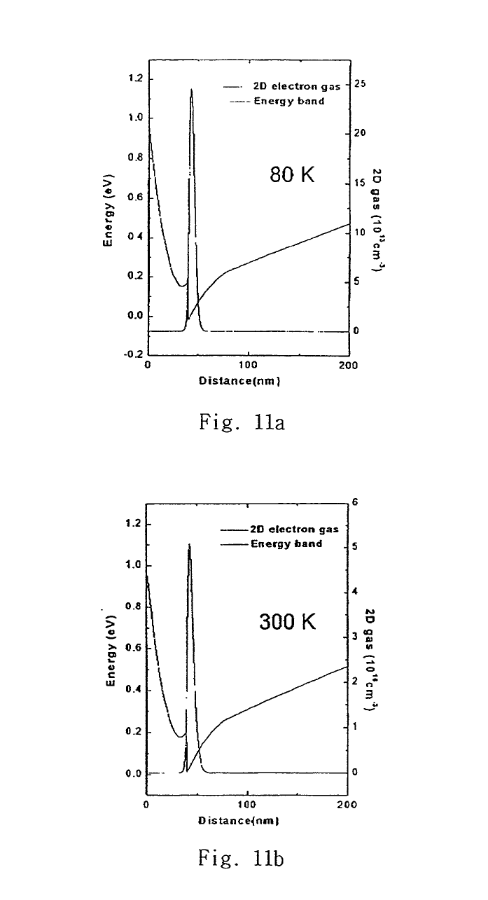

FIGS. 10a and 10b are test graphs for the photo detect device according to the first embodiment, in which the detect electrodes are 7 μm apart from each other and 200 μm wide. The impurity layer has an impurity concentration of 1×10¹⁸/cm³. The depth of the concaved layer was so controlled as for the dark current to be several nA or less by providing the carriers to the quantum dots, but not to the pseudo 2-D conduction path formed as a result of heterojunction. The detectivity thus obtained was 3×10⁷ cmHz^{½}/W at room temperature and 6×10¹⁰ cmHZ^{½}/W at 80 K.

Referring to FIGS. 12a and 11b, there are energy band diagrams for the photo detect device using quantum dots, in accordance with the first embodiment of the present invention. In these diagrams, although being omitted, the quantum dot layers are present in practice.

FIGS. 12a and 12b illustrate the confinement state of electrons within the quantum dots.

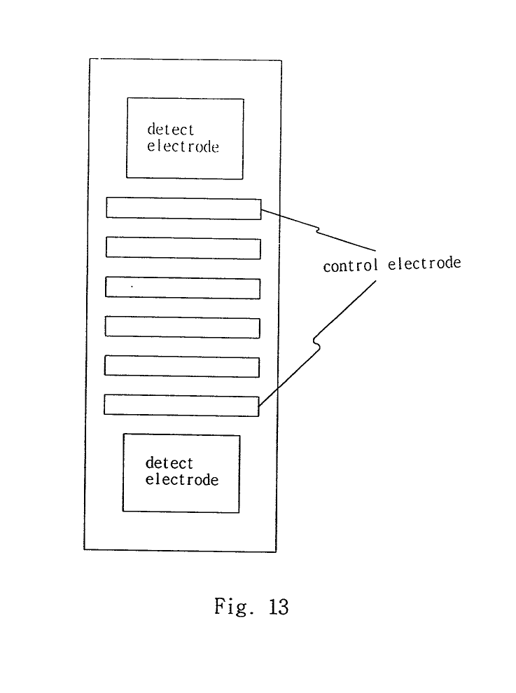

With reference to FIG. 13, there is a plan through a photo detect device according to a third embodiment of the present invention. As shown in this figure, this photo detect device comprises two detect electrodes between which at least two control electrodes are formed. Electric fields different in magnitude are subsequently applied to the neighboring control electrodes to transfer to the detect electrodes the charges formed below the control electrode as a result of the response to infrared light, in sequence.

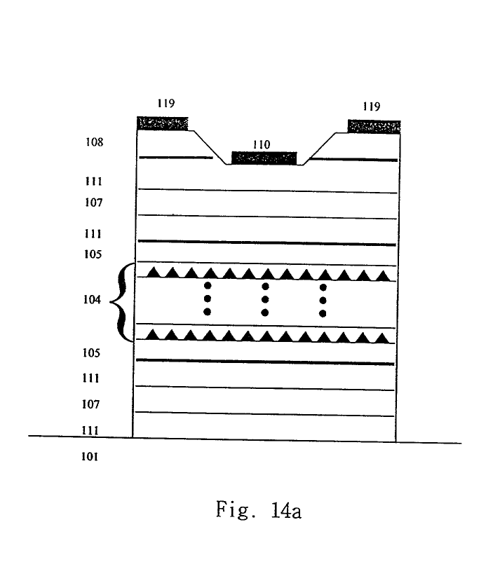

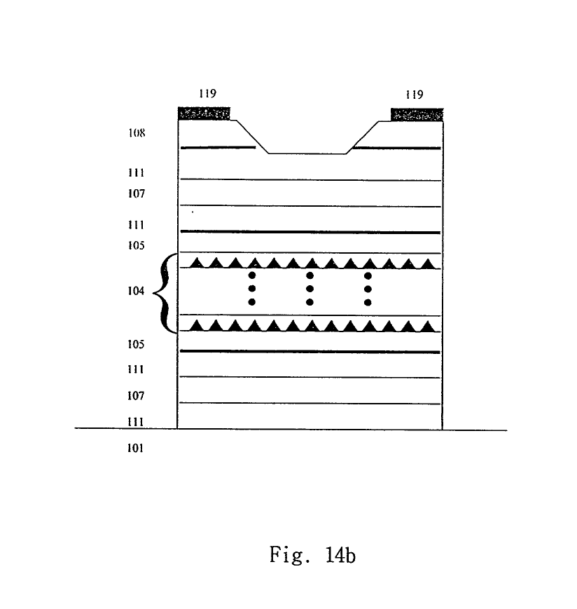

FIGS. 14a and 14b are a section through a photo detect device using double heterostructure conducting paths which are overlapped with quantum dot light detecting layers, according to another embodiment of the present invention. Undoped AlGaAs layers 111 are added.

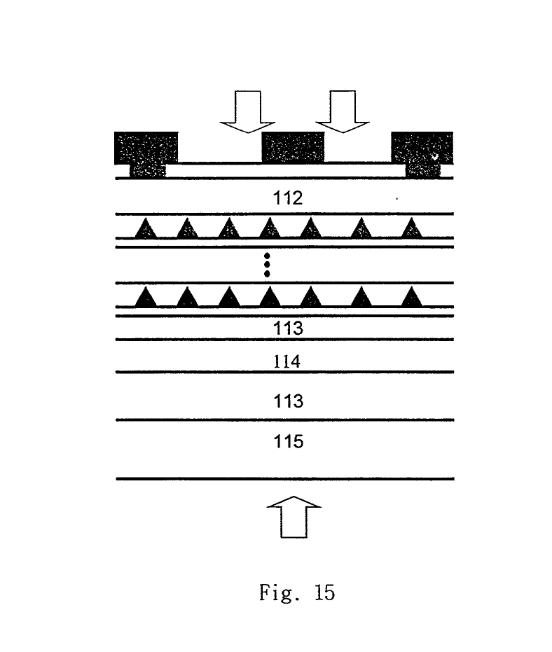

FIG. 15 is a section through a photo detect device using Si/SiO₂ interface as a conducting path according to another embodiment of the present invention. N-type Si 112, undoped Si 113, delta-doped Si 114, n-type Si substrate 115 are added to this structure.

As described hereinbefore, the photo detect device according to the present invention can detect the light incident normally on infrared detect elements or their array face efficiently and susceptibly and is well operable at room temperature without additional equipment or treatments.

Further, the photo detect device has a structure which is easy to form into a two-dimensional array. In addition, another embodiment of the present invention provides a photo detect device structure in which the carriers formed as a result of the response to infrared light can be sequentially detected by using sequential charge transfer. Thus, the photo detect device according to the present invention can be fabricated economically.

The present invention has been described in an illustrative manner, and it is to be understood the terminology used is intended to be in the nature of description rather than of limitation.

Many modifications and variations of the present invention are possible in light of the above teachings. Therefore, it is to be understood that within the scope of the appended claims, the invention may be practiced otherwise than as specifically described.

What is claimed is:

1. A materialization method of a photo detect device using quantum dots, in which the transfer and channels of carriers are set in the horizontal direction by heterointerfaces, insulator/semiconductor interfaces and impurity doping and the magnitude of the currents which flow through the channels is determined by the control of Fermi level, comprising the steps of:
forming quantum dot layers at predetermined positions near the channels so as to influence the potential of the channels in such a manner that the carriers should be released from the quantum dot layers in response to light detection and accumulated in the channels; and
providing the Fermi level at an activation position by confining the carriers within the quantum dot layers while limiting the number of the carriers in the channels for the purpose of minimizing a current flow in the absence of incident light.

2. A materialization method as set forth in claim 1, wherein the light is infrared light ranging, in wavelength, from 0.77 μm to 100 μm.

3. A photo detect device using quantum dots, comprising:
at least one quantum dot layer containing the quantum dots located near channels of carriers so as to influence the potential of the channels;
at least one light absorption layer containing at least one quantum dot layer, which is formed by alternating the quantum dot layer and a material different in band gap from the quantum dot layer;
at least one conduction path layer, in contact with the at least one light absorption layer, in which carriers excited in the light absorption layers are collected and conducted in a horizontal direction;
at least one impurity-containing layer in which impurities are so controlled in amount and distribution as to provide the carriers to the at least one light absorption layer, but not to the at least one conduction path layer;
at least two detect electrodes for conducting in the horizontal direction the carriers which are accumulated in the channels in response to the light incident on the at least one light absorption layer; and
one contact layer on which detect electrodes are formed to collect and to provide carriers.

4. A photo detect device as set forth in claim 3, wherein the at least two detect electrodes have a distance therebetween which is longer than the wavelength of the incident light in the device.

5. A photo detect device as set forth in claim 3, wherein the distribution of the impurities in the at least one impurity-containing layer take a shape of a delta function.

6. A photo detect device as set forth in claim 3, wherein the at least one impurity-containing layer have a uniform distribution of the impurities therethrough and are etched to control the number of carriers provided to the quantum dots.

7. A photo detect device as set forth in claim 3, wherein the at least one impurity-containing layer and the at least one light absorption layer are formed adjacent to the at least one conduction path layer.

8. A photo detect device as set forth in claim 3, wherein the at least one impurity-containing layer and the at least one light absorption layer are formed to be overlapped with the at least one conduction path layer.

9. A photo detect device as set forth in claim 3, wherein the at least one impurity-containing layer, the at least one conducting path layer and the at least one light absorption layer are made to have different band gaps so as to be subjected to heterostructures.

10. A photo detect device as set forth in claim 3, further comprising at least one control electrode for controlling the amount of the carriers provided to the at least one light absorption layer and the at least one conduction path layer.

11. A photo detect device as set forth claim in 10, wherein impurities which are opposite, in type, to those in the at least one impurity-containing layer are doped below the bottom layer of the at least one control electrode, to reduce leak currents of the at least one control electrode.

12. A photo detect device as set forth claim in 10, wherein a highly resistant layer is provided below the bottom layer of the at least one control electrode to reduce leak currents of the at least one control electrode.

13. A photo detect device as set forth in claim 10, wherein at least two control electrodes are used and provided sequentially with electric fields different in magnitude, so as to detect the carriers accumulated in the channels beneath the at least two control electrodes, in sequence.

14. A photo detect device as set forth in claim 13, wherein impurities which are opposite, in type, to those in the at least one impurity-containing layer are doped below a bottom layer of the at least two control electrodes, to reduce leak currents of the at least two control electrodes.

15. A photo detect device as set forth in claim 13, wherein a highly resistant layer is provided below the bottom layer of the at least two control electrodes to reduce leak currents of the at least two control electrodes.

16. A photo detect device as set forth in claim 13, wherein the at least two control electrodes are formed into at least two layer s lest the control electrode in one layer may overlap with that in another layer, a matter with a large resistance is interposed between the at least two control electrode layers, and electric fields different in magnitude are subsequently applied to the at least two control electrodes, whereby the charges accumulated in the channels beneath the at least two control electrodes can be, in sequence, detected.

17. A photo detect device as set forth in claim 16, wherein impurities which are opposite, in type, to those in the at least one impurity-containing layer are doped below the bottom layer of the at least two control electrodes, to reduce leak currents of the at least two control electrodes.

18. A photo detect device as set forth in claim 16, wherein a highly resistant layer is provided below a bottom layer of the at least two control electrodes to reduce leak currents of the at least two control electrodes.

19. A method for fabricating a quantum dot-employing photo detect device, comprising the steps of:
growing light absorption layers in such a way that quantum dots are naturally formed in the course;
depositing at least two electrode on a contact layers to show horizontal conduction;
reducing the resistance between the electrode and the contact layer;
etching the edge of the device to an extent necessary to reduce an electrical connection to other neighboring devices;
etching the contact layer and/or a carrier supplying layer to a depth necessary to control the amount of carriers provided to the quantum dots;
depositing at least one control electrode for controlling the carriers provided to the quantum dots;
depositing an insulating film to prevent a short circuit from being formed between the electrodes; and
etching a predetermined portion of the insulating film to transfer desired electrical signals to the outside of the insulating film.
